(19) United States
(12) Patent Application Publication
(10) Pub. No.: US 2021/0356440 A1
(43) Pub. Date: Nov. 18, 2021

(54) Gas Chromatography System and Method

(71) Applicant: PHOENIX FIRST RESPONSE, LLC, Glassport, PA (US)

(72) Inventor: Scot D Abbott, Pittsburgh, PA (US)

(21) Appl. No.: 16/340,773

(22) PCT Filed: Oct. 17, 2017
(86) PCT No.: PCT/US17/56914

§ 371 Date: Apr. 10, 2019

Related U.S. Application Data
(60) Provisional application No. 62/409,421, filed on Oct. 18, 2016.

(51) Int. Cl. G01N 30/30

(52) U.S. Cl. CPC G01N 30/30; G01N 2030/025; G01N 2030/3007

(57) ABSTRACT

A system or method for gas chromatography has a spool member constructed from a base section and a cover plate. The base portion has a base plate section connected to a wall section. The base plate section and the wall section define a hollow cavity for receiving a fluid. The cover plate is attachable to the base section to seal the cavity. A heating device is attached to and maintains thermal contact with an exterior surface of the spool member. Inlet and outlet ports disposed in the cover plate are in fluid communication with the cavity for introducing a fluid coolant source. Thermally conductive tubes are in thermal contact with an exterior surface of the wall section for transferring heat to a fluid column of analyte within the conductive tubes. The spool member is heated with the heating device during a gas chromatography heating cycle.

### CROSS-REFERENCE TO RELATED APPLICATIONS

This application claims priority to and the benefit of U.S. Provisional Patent Application Ser. No. 62/409,421 filed Oct. 18, 2017, entitled “GAS CHROMATOGRAPHY SYSTEM AND METHOD”, which is hereby incorporated by reference in its entirety.

### BACKGROUND

The application generally relates to a gas chromatography (GC) method and system. The application relates more specifically to a gas chromatography system including a spool having a liquid-tight reservoir for changing the temperature of the gas column.

Gas chromatography is performed in a special instrument where a small amount of a mixture is injected into an apparatus and swept through a column in a stream of gas, such as helium nitrogen or hydrogen under conditions where its components separate into pure compounds. The column is usually located in a heated oven in order to facilitate the separation. Just before each compound exits the instrument, it passes through a detector, which sends an electronic message to the recorder or to a computer for signal processing.

Typically the column is heated by placing the column in a forced air oven. Alternatively, the GC column is heated by direct resistance heating of the column itself. The heat facilitates compound separation by raising the column temperature and speeding up the compounds in the mixture. This direct electrification method only can be used with electrically conductive columns, and it introduces the possible hazard of electrical shock. In some instances column temperature may be controlled to within tenths of a degree. The optimum column temperature or time temperature profile depends on the chromatography and sample of interest.

Analytes may be assayed at different temperatures, including high temperatures such as 500° C. If the column temperature is increased during the run, then it must be reduced before the next sample can be run. It is necessary to cool the column prior to testing additional samples. Long cooldown periods are problematic because they lengthen the sample cycle time and reduce productivity. Delay may be compounded where a gas chromatograph is needed to analyze a large number of samples containing the same or different analytes of interest. Valuable time may be wasted while waiting for the column and oven to cool prior to testing additional samples.

Existing GC systems disclose a GC assembly having a relatively high thermal mass, thermally conductive body. The body may have a conductive body to carry separation columns in heat transfer relationship. Chromatographic columns can be coiled around external surfaces of a spool-like device with heat-transfer fins that provide heat exchange between the columns and a heat source. The interior of the cell and the separation columns may be heated with a single heating element, or elements with control means, e.g., a silicon heating pad or cartridge heater. However, such devices lack any means for cooling the GC columns.

Other GC systems have a heater/fan assembly for establishing a temperature-controlled zone. An insulating enclosure confines the temperature-controlled zone to an oven cavity and zones of the pneumatic manifold. A separation column has ends attached to couplers at selected internal conduits in the pneumatic manifold. The columns are located close to the manifold within the temperature-controlled zone. The separation columns are positioned within an oven cavity within the manifold.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

Another advantage of this arrangement is the ease of sub-ambient capability without additional complications (e.g. use of liquid nitrogen, refrigeration of oven, etc.).

### BRIEF SUMMARY OF THE INVENTION

One embodiment relates to a gas chromatography system. The GC system includes a spool member constructed from a base section and a cover plate. The base portion has a base plate section connected to a wall section. The base plate section and the wall section define a hollow cavity for receiving a fluid. The cover plate is attachable to the base section to seal the cavity. A heating device is attached to and in thermal contact with an exterior surface of the spool member. Inlet and outlet ports disposed in the cover plate are in fluid communication with the cavity for introducing a fluid coolant source. Thermally conductive tubes are in thermal contact with an exterior surface of the wall section for transferring heat to a fluid column of analyte within the conductive tubes. The spool member is heated with the heating device during a gas chromatography heating cycle.

Another embodiment relates to a method of analyzing constituents of an analyte, the method comprising providing a spool member with a hollow cavity for containing a cooling fluid; providing a thermally conductive coil in thermal contact with the spool member; heating the spool with a heating element in thermal contact with the spool member; performing a temperature cycling of the thermally conductive coil while controlling heat transfer through the spool member; upon completion of the heating cycle, introducing a cooling fluid into the hollow cavity; cooling the spool member to a predetermined temperature; and discharging the cooling fluid to substantially empty the cavity and thereby reducing the thermal mass of the spool member.

The subject matter of the invention under consideration is directed to a gas chromatography (GC) method and system. The improved GC system eliminates the need for an oven to heat the column of gas as is currently done in order to control the temperature for chromatography analysis.

Still another advantage is that the GC column of the present invention further eliminates the need for cooling fans and thus reduces the explosion hazards, e.g., when hydrogen is used as a carrier gas. In some GC systems hydrogen is preferred as a carrier gas due to its low cost and excellent performance characteristics. It is known that hydrogen may present an explosion hazard in confined areas, e.g., if a leak develops and/or an ignition source is present. The presently disclosed GC system may diminish the hazard associated with hydrogen since the hydrogen gas is not confined in an area, and ignition sources such as fan motors are also not required.

The disclosed GC column and method provides a stable, rapid heating and rapid cooling arrangement for GC columns.

Another advantage is the ability to change the practical rate of heating by changing the thermal mass during operation, i.e., by increasing or decreasing the amount of liquid in the reservoir.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1 is an elevational view of a gas chromatograph spool (GC spool) of the present invention.

FIG. 2 is a cross-sectional view of the GC spool of FIG. 1, taken along the lines 2-2.

FIG. 3 is a plan view of the top cover plate of the GC spool.

FIG. 4 is a sectional view of the top plate of FIG. 3, taken along the lines 4-4.

FIG. 5 is a schematic view of the GC system.

Wherever possible, the same reference numbers will be used throughout the drawings to refer to the same or like parts.

### DETAILED DESCRIPTION OF INVENTION

Before turning to the figures which illustrate the exemplary embodiments in detail, it should be understood that the application is not limited to the details or methodology set forth in the following description or illustrated in the figures.

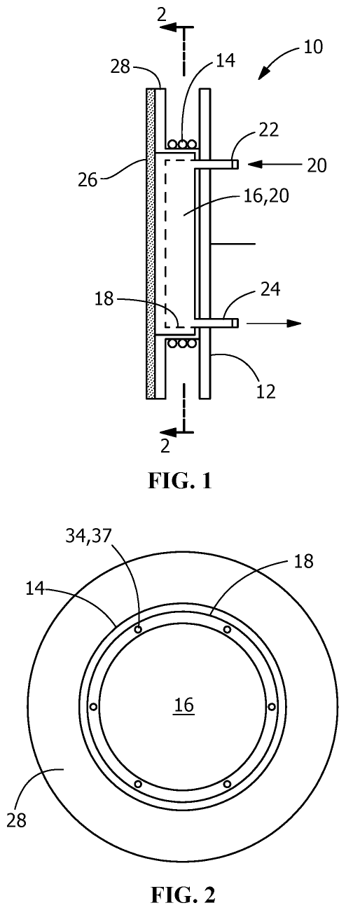

Referring to FIGS. 1-4, a GC system 10 includes a gas column holder or spool 12 for a GC system 10. Spool 12 is arranged with components to enable it to heat and cool GC columns 14 without using the conventional oven as the heat source. Spool 12 may have one or more tubular coil columns 14 configured on one column holder or spool 12. Spool 12 may be constructed of thermally conductive materials. In one embodiment spool 12 is constructed of aluminum. Spool 12 includes a cavity 16 defined by a cylindrical core wall 18. Cavity 16 is hollow and may be filled or flushed with a liquid coolant 20.

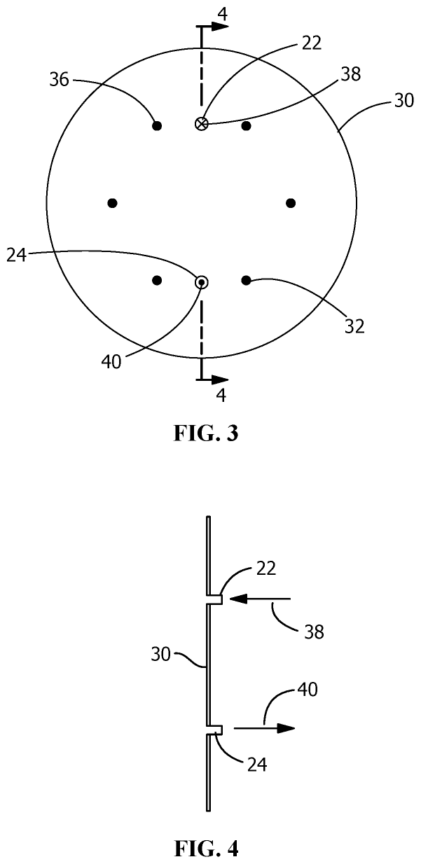

As shown in FIG. 3, cavity 16 receives liquid coolant 20 via one or more inlet ports 22, and discharges liquid coolant via one or more outlet ports 24. In the embodiment shown in FIG. 1 there is one inlet port 22 and one outlet port 24, but more inlet ports and outlet ports may be provided as required by the flow characteristics and thermal mass of the system 10.

The column 14 is coiled around the core wall 18 of spool 12 in a manner which promotes efficient thermal contact and thermal transfer between the spool wall 18 and the columns 14. In operation, spool 12 can be heated using various heat sources 26, in order to controllably increase the temperature of the gas flowing in columns 14. In the embodiment shown in FIG. 1 a silicon pad heater or similar heat source 26 is applied in thermal contact to base plate 28 to allow GC column 14 to be heated in a desired temperature-time path. Then, as desired, the GC spool 12 can be cooled by flushing cavity 16 with a coolant fluid 20, e.g., via a tube fitting connector for ports 22, 24 in the cover plate 30 (FIG. 3) of spool 12. Once spool 12 is cooled to the desired temperature cooling fluid 20 can be removed, e.g. by siphoning effect, to minimize thermal mass and facilitate rapid heating.

Referring next to FIGS. 3 and 4, cover plate 30 includes inlet ports 22 and outlet ports 24 for charging and discharging cooling fluid 20 as indicated by arrows 38, 40 respectively. Holes 36 are drilled through cover plate 30 to receive bolts 34 for threadably attaching cover plate 30 to internally threaded bolt recesses 37 in core wall 18 with a liquid-tight seal. A gasket (not shown) may be included between cover plate 30 and core wall 18 in order to ensure the liquid-tight seal between cover plate 30 and core wall 18.

The disclosed invention eliminates the need for a conventional oven for heating a GC column. The GC spool 12 facilitates rapid cool down and ease of use for sub-ambient conditions, and is inexpensive and simple to construct. Aspects of the invention include balancing of thermal mass, heating capabilities, the mechanical nature of the GC columns, improved thermal contact, and cooling capabilities for completing GC sample runs in 10 minutes or less of total cycle time. Furthermore, the GC system 10 requires substantially less laboratory space than prior art GC systems that commonly employ ovens for heating the GC column(s).

A GC cycle may be controlled via electronic digital or analog electronic controllers which are well known in the art.

The cooling fluid inlet and outlet lines may include valves controllable for filling and draining the cavity, and for circulating the cooling fluid within the cavity.

The heating device may be attached to one or both of the base plate section and the cover plate section for heating the spool and the contents of the cavity.

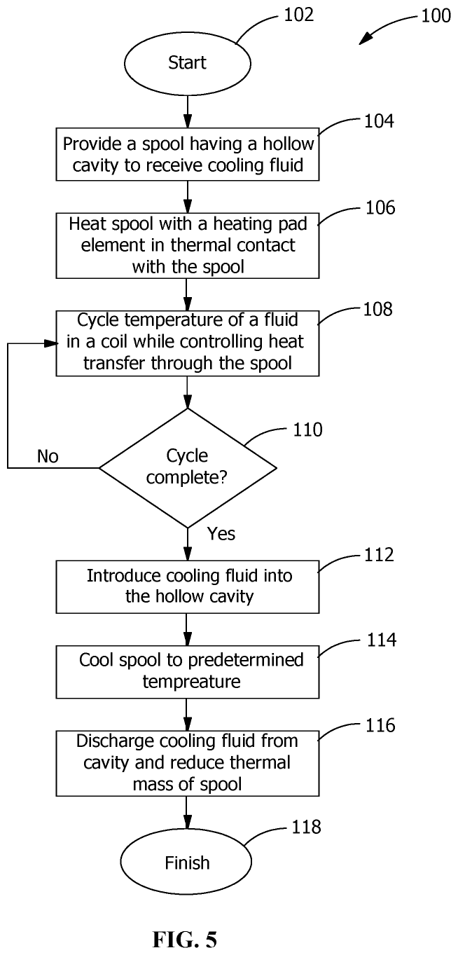

Referring next to FIG. 5, a method 100 of analyzing constituents of an analyte is shown. The method 100 is initialized at 102, and proceeds at step 104 to provide a spool member with a hollow cavity for containing a cooling fluid and a thermally conductive coil in thermal contact with the spool member. Next, method 100 proceeds at step 106 to heating the spool with a heating element in thermal contact with the spool member. At step 108, the method 100 proceeds with temperature cycling of the thermally conductive coil while controlling heat transfer through the spool member. At step 110, if the heating cycle is determined to be completed, the system 100 proceeds at step 112 by introducing a cooling fluid into the hollow cavity of the spool. At step 114 the method cools the spool member to a predetermined temperature; and at step 116 discharges the cooling fluid to substantially empty the cavity and thereby reduces the thermal mass of the spool member. At step 110, if the heating cycle is determined to be incomplete, then the method 100 returns to step 108 and continues with the heating cycle. After step 116, the method is complete at step 118. The method may be repeated through the temperature cycle again after completion at step 118.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the gas chromatography system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

A gas chromatography system comprising a spool member comprising a base section and a cover plate; the base portion having a base plate section connected to a wall section; the base plate section and the wall section defining a hollow cavity for receiving a fluid; the cover plate being removably attachable to the base section to seal an open end of the cavity; a heating device attached to and in thermal contact with at least an exterior surface of the spool member; at least one inlet port and at least one outlet port in fluid communication with the cavity for introducing a fluid coolant source; at least one thermally conductive tube in thermal contact with an exterior surface of the wall section for transferring heat to a fluid column of analyte; wherein the spool member is heated with the heating device during a gas chromatography heating cycle.

In one embodiment the spool member is cooled following the GC heating cycle by introducing a fluid from the coolant source into the cavity; and the fluid is discharged from the cavity to reduce a thermal mass of the spool member prior to a subsequent GC heating cycle.

1. A gas chromatography system comprising:
a spool member comprising a base section and a cover plate;
the base portion having a base plate section connected to a wall section; the base plate section and the wall section defining a hollow cavity for receiving a fluid;
a heating device attachable to and in thermal contact with the spool member;
at least one inlet port and at least one outlet port in fluid communication with the cavity for introducing a fluid from a coolant source;
at least one thermally conductive tube in thermal contact with the wall section for transferring heat to a fluid column of analyte;
wherein the spool member is controllably heated with the heating device to perform a gas chromatography heating cycle.

2. The system of claim 1, wherein the spool member is cooled following the GC heating cycle by introducing the fluid from the coolant source into the cavity.

3. The system of claim 2, wherein the fluid is discharged from the cavity to reduce a thermal mass of the spool member.

4. The system of claim 1, wherein at least an exterior surface of the spool member is in thermal contact with the heating device.

5. The system of claim 1, wherein the cover plate is configured to seal an open end of the cavity when attached to the base section.

6. The system of claim 1, wherein the at least one thermally conductive tube in thermal contact with the wall section on an exterior surface of the wall section.

7. The system of claim 1, wherein the gas chromatography heating cycle being controllable via digital controller.

8. The system of claim 1, wherein the gas chromatography heating cycle being controllable via analog electronic controller

9. The system of claim 1, further comprising at least one valve in fluid communication with at least one of the inlet port or outlet port;
the at least one valve controllable for filling and draining the cavity, and for circulating the cooling fluid within the cavity circulating the fluid.

10. The system of claim 1, wherein the cover plate is removably attachable to the base section.

11. A gas chromatography method comprising:
providing a spool member with a hollow cavity for containing a cooling fluid;
heating the spool member with a heating element in thermal contact with the spool member;
performing a temperature cycling of fluid in a coil while controlling heat transfer through the spool member;
upon completion of the heating cycle, introducing a cooling fluid into the hollow cavity; and
cooling the spool member to a predetermined temperature.

12. The method of claim 11, further comprising reducing a thermal mass of the spool member by discharging the cooling fluid to substantially drain the cooling fluid from the cavity.

13. The method of claim 11, wherein the step of heating the spool member comprises providing a thermally conductive coil in thermal contact with the spool member

14. The method of claim 11, wherein the cooling coil is thermally conductive.

15. The method of claim 11, wherein controlling the temperature cycling is achieved via a digital controller.

16. The method of claim 11, wherein controlling the temperature cycling is achieved via an analog controller.

17. A gas chromatography system comprising:
a controller in communication with thermal sensor and a heating device for controlling a gas chromatography thermal cycle;
the controller configured to:
heat a spool member with a heating element in thermal contact with the spool member;
perform a temperature cycling of fluid in a coil while controlling heat transfer through the spool member;
upon completion of the heating cycle, introduce a cooling fluid into the hollow cavity; and
cool the spool member to a predetermined temperature;
a spool member comprising a base section and a cover plate;
the base portion having a hollow cavity for receiving a fluid;
a heating device attachable to and in thermal contact with the spool member;
at least one inlet port and at least one outlet port in fluid communication with the cavity for introducing a fluid from a coolant source; and
at least one thermally conductive tube in thermal contact with the wall section for transferring heat to a fluid column of analyte.

18. The method of claim 17 wherein the cavity comprises a base plate section connected to a wall section.

19. The method of claim 17, wherein the spool member is controllably heated with the heating device to perform a gas chromatography heating cycle.

20. The method of claim 17, wherein the at least one thermally conductive tube comprises multiple thermally conductive separate tubes in thermal contact with the wall section for transferring heat to multiple fluid column of analyte, the fluid columns isolated from one another.
